(19) United States
(12) Patent Application Publication
(10) Pub. No.: US 2003/0055835 A1
(43) Pub. Date: Mar. 20, 2003

(54) System and method for transferring biological data to and from a database

(76) Inventor: Chantal Roth, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/938,712

(22) Filed: Aug. 23, 2001

(51) Int. Cl. G06F 17/00

(52) U.S. Cl. 707/102

(57) ABSTRACT

The present invention relates to systems and methods for formatting and storing data and information collected from diverse biological domains. A uniform method of processing data output from biological sources of information uses an intermediary markup language to reformat the data output and organize the information contained therein for subsequent storage in a data warehouse. A generic loader is implemented and configured to receive data in a transitional format, transpose the data into a database-compatible language and store the data in a data warehouse.

### BACKGROUND OF THE INVENTION

1. Field of the Invention

The present invention relates to the field of bioinformatics and more particularly, relates to a system and method for populating and maintaining a complex database of biological information.

2. Description of the Related Art

Modern biological sequencing efforts, such as those underway for the complete sequencing of the entire human genome, as well as, newly developed experimental techniques for biological analysis, have resulted in an unprecedented amount of information which must be compiled, integrated and stored. The field of bioinformatics uses computing technologies to manage the large quantities of biological information and perform data analysis using the collected information.

In the application of bioinformatics to the study of complex biological processes, numerous tools and applications have been developed which use computers to acquire, process, and store information related to the biological systems under study. The inherent complexity of biological processes has resulted in the development of individual bioinformatic tools typically directed towards data acquisition and analysis for smaller subsets of biological information. This information is typically maintained in multiple specialized databases designed to be independently accessed. These databases represent different biological domains, such as nucleotide sequences, protein sequences, molecular structures, pathways, physical maps, genetic maps, markers, etc. Existing database design strategies have provided only limited functionality to allow for simultaneous analysis across these multiple domains.

The inherent interrelationship between the different biological domains and data types make biological study and research less effective when performed in an isolated manner. One way of performing efficient biological study and research is to compile a single database containing the relevant information of interest. However, compiling a collection of relevant biological domains extracted from independent sources has been problematic because of the disparate database design strategies. To this end, there is a long felt need for a system which can unify the scientific data contained in the databases and provide functionality for analysis across the different biological domains both independently and collectively. Accordingly, large-scale bioinformatic and molecular biology data integration has been difficult to achieve.

One problem exists in integrating the many different types of biological data so it can be stored in a single database or group of related databases. The problem stems from the lack of standardization across all data types and the different settings in which the data is acquired and used. Attempts to process biological information in the form of sequence information (RNA, DNA, protein), biological assay/experimental data, chemical structure data, expression data and other data types has resulted in numerous applications and database methods, each of which have differing formats and descriptors. For example, it is typically the case that sequence data obtained from genomic or proteomic work cannot be readily combined with chemical reaction, pathway, or metabolic biological data. One reason for this lack of integration resides in the inherent differences in the structure of the data sets, making it difficult to design methods which combine the data sets in a meaningful manner that allow combined search, query, and analysis functionality in a unified software package. Additionally, the currently accepted native data formats for biological data are not compatible with one another and thus require processing filters, or reformatting programs, to allow the data to be integrated into a single database or group of databases.

A further problem exists with existing biological databases and data processing applications which have limited data independence. In many biological databases, the schema for the database, or the method in which it is implemented, often results in a limited ability to integrate new data types and applications without substantial redesign of the existing components. This problem is exacerbated by the rapid and continual development of new biological techniques, approaches, and data sets which must be integrated into existing databases if they are to be kept up-to-date and provide maximal functionality.

Additionally, the user interfaces to the applications which analyze the different biological domains and data sets typically are limited and do not provide common tools or resources which can be shared across all of the biological domains or data types under study. Current multi-domain biological data analysis methods require the use of multiple software packages which must be run independently and do not provide similar functionality, thereby further hindering data analysis.

Thus, there is a need for improved methods and applications which provide the power and flexibility to meet the demands of data integration in a complex and dynamic system. The system should have the characteristic feature of database independence, in order to allow data from different databases and schemas to be accessed, processed, and stored without having to devote large amounts of time to rewrite the code for existing databases or components and to minimize the changes to existing database needed to update the system with new functionalities.

### SUMMARY OF THE INVENTION

The aforementioned needs are satisfied by the present invention, which in one aspect comprises an integrated architecture designed to be highly scalable and capable of integrating many different data types into a data warehouse. The data warehouse comprises a relational database implemented using a structured data language, such as the extensible markup language (XML), specification to simplify data loading, provide automatic code generation, and enable configuration of a single tool set rather than requiring the generation of many independent tools for different data types.

Embodiments of the invention provide a system configured to receive non-uniform data from multiple biological databases, convert the data into a standardized XML file, process the XML file and embed any necessary mapping information, convert the XML file into a standardized database language, such as SQL statements, and load the data into a data warehouse for storing and making the data available to a plurality of research tools.

More specifically, embodiments of the invention focus on a generic data loading module for storing and integrating data entries into a data warehouse. The data loading module includes a loader module which receives data in a structured data format, converts the structured data format into formatted data, and stores the formatted data in a data warehouse. Additionally, the loader is able to combine the formatted data with mapping information to properly and logically associate the data to the proper table or tables in the database. Furthermore, the loader is configured with additional tools to allow efficient handling of large files, data verifiers to ensure that data entries are complete, and automatic key generators to properly store the data in the data warehouse and logically associate the data with other data present in the data warehouse.

### BRIEF DESCRIPTION OF THE DRAWINGS

These and other features will now be described with reference to the drawings summarized below. These drawings and the associated description are provided to illustrate embodiments of the invention and not to limit the scope of the invention. Throughout the drawings, reference numbers are re-used to indicate correspondence between referenced elements.

FIG. 1 illustrates a high-level block diagram of one embodiment of a bioinformatics integration system.

FIG. 2 illustrates a high-level block diagram of a non-uniform data transformation process.

FIG. 3 illustrates one embodiment of a data transformation method as applied to sequence data files.

FIG. 4 illustrates a block diagram of one embodiment of database mapping utilizing a mapping file.

FIG. 5 illustrates a block diagram of one embodiment of database mapping utilizing integrated mapping tags.

FIG. 6 illustrates one embodiment of a mapping software product.

FIG. 7 illustrates a block diagram of the functionality of a generic XML Loader.

FIG. 8 illustrates one embodiment of a loader module with associated functionality.

FIG. 9 is a flow diagram illustrating one embodiment of a data transformation and loading process.

### DETAILED DESCRIPTION

Overview

Embodiments of the invention relate to retrieving data from multiple data sources and storing the data into a centralized data warehouse for subsequent retrieval and analysis. Embodiments of the present invention advantageously allow non-uniform data from a plurality of data sources to be conveniently loaded into a single integrated database. This eliminates the need for a plurality of specifically designed search and analysis tools designed to be used with each individual data source. It further enables data of interest to be stored in a single database location, thus reducing the time required to search and retrieve data records from multiple sources.

Reference will now be made to the drawings wherein like numerals refer to like parts throughout.

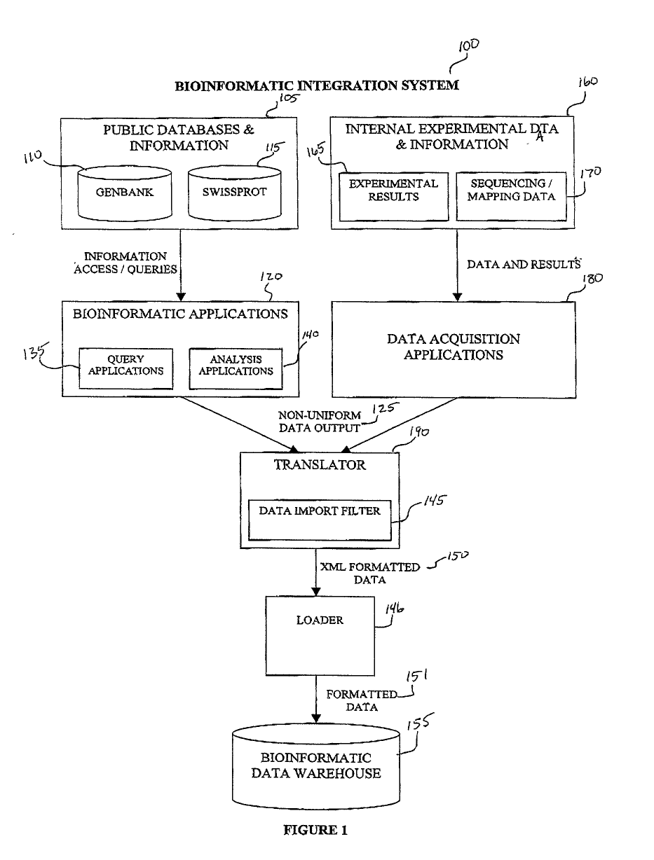

FIG. 1 illustrates one embodiment of the invention comprising a bioinformatic integration system 100. In one aspect, the bioinformatic integration system 100 facilitates the collection, storage, processing, analysis and retrieval of many different data types related to the study of biological systems. In the illustrated embodiment, data is collected from a plurality of information sources and integrated into a data warehouse 155.

In one aspect, data and information is obtained from publicly accessible databases and collections of genetic and biological information 105. The national nucleotide sequence database, GenBank 110, represents one such source of information. GenBank 110 is a computer-based data repository containing an annotated database of all published DNA and RNA sequences. As of February 2001, over 11,720,000,000 bases in 10,897,000 sequence records were contained within this collection.

Each annotated sequence record in GenBank 110 contains raw sequence information along with additional information supplementary to the sequence information. In one aspect, the supplemental information comprises biological origins of the sequence, investigators who recovered the sequence, experimental conditions from which the sequence was derived, literature references, cross-references with other sequences, and other informational entries which provide support information for the nucleotide sequence or gene. Similarly, SwissProt 115 is an annotated protein sequence database maintained collaboratively by the Swiss Institute for Bioinformatics (SIB) and the European Bioinformatics Institute (EBI). Like GenBank 110, the information contained in this data repository 115 extends beyond simple sequence information and includes supporting information and cross-references useful in further biological analysis.

The two publicly accessible information sources, GenBank 110 and SwissProt 115, are but two examples of the many different informational sources available for searching and information retrieval. Other informational sources include PubMed (a biomedical literature repository), Molecular Modeling Database (containing 3-dimensional macromolecular structures including nucleotides and proteins), Entrez Genomes (a whole sequence listing for the complete genomes of individual organisms), PopSet (a set of DNA sequences that have been collected to analyze the evolutionary relatedness of a population), NCBI taxonomy database (contains the names of all organisms that are represented in genetic databases), among other sources and databases of biological sequence and research information. It will be appreciated by those of skill in the art, that other publicly accessible informational sources exist whose information may be desirably incorporated into the data warehouse 155 by the bioinformatic integration system 100.

The information and sequence records contained in the public databases 105 are typically accessible using programs or applications collectively referred to as bioinformatic applications 120. The bioinformatic applications or programs 120 access the information contained in the databases 105 in a number of ways:

One method of information searching and data acquisition involves the use of networked computers wherein one computer stores the biological information/database and hosts accessibility by other computers. In one aspect, a user may interact with the public databases 105 stored on a host computer using a query application 135. The query application 135 may further be executed through a networking application, web browser or similar application used to remotely connect to, and access, information stored in the public databases 105 wherein the host computer performs searches and data analysis based on commands issued by the query application 135. The host computer subsequently returns the results to the query application 135 where it may be viewed, saved, and further processed.

Alternatively, the public databases 105 can be accessed using specifically designed or proprietary analysis applications 140 which query, retrieve and interpret information contained in the public databases 105 directly. These analysis programs 140 may access the informational databases 105 and may contain additional functionality to process, analyze and categorize the information and databases 105 to facilitate their use.

The abovementioned bioinformatic applications 120 typically produce non-uniform data 125, which comprises the results of querying the public databases 105. The data received from these queries is typically in a proprietary format specific to each application. In one aspect, the bioinformatic integration system 100 transforms the non-uniform data 125 from a plurality of different, and potentially incompatible, sources into a single uniform data format source using a plurality of data translators 145. As will be subsequently discussed in greater detail, each data translator 145 organizes the non-uniform data 125 by capturing and transforming the data into a formatted data type 150, such as the extensible markup language, to be stored in the data warehouse 155. The formatted data is desirably structured to contain all the fields within the non-uniform data 125 from the many various informational sources 105.

Another source of information which is incorporated into the data warehouse 155 is derived from internally generated experimental data and information 160. In one aspect, the internal information 160 comprises data and results obtained from laboratory experiments conducted locally or in collaboration with others or is otherwise not available from public data sources. Internal information 160, may for example, be derived from experimental results 165 conducted in specific areas of interest to the user of the bioinformatic integration system 100. Additionally, data 170 accumulated from instrumentation and computers, such as, for example, instruments dedicated to specific sequencing and mapping projects, may be incorporated into the data warehouse 155.

In one aspect, the experimental data and information 160 acquired from locally maintained sources are collected using a data acquisition application 180. The data acquisition application 180 processes the data 160 so that it can be stored in a pre-determined domain of the data warehouse 155. This data may include, for example, the software and applications used to acquire data 170 from protein/nucleotide sequencing devices, gene expression or profiling instrumentation, researcher maintained databases of experimental results, and other instruments and sources of information accessed by the user of the bioinformatic integration system 100 which is combined and analyzed.

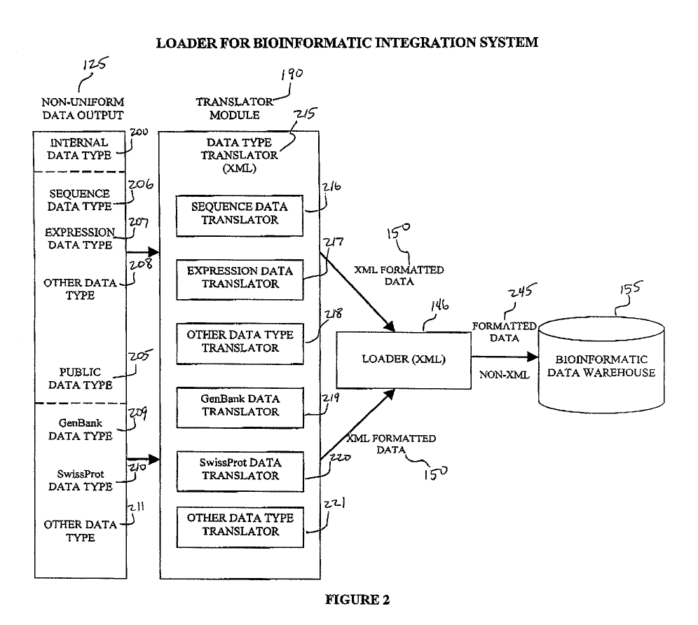

The data acquisition application 180 stores the data and results from the aforementioned internal data and information sources 160 to produce non-uniform data 125 which may not be uniform in nature. The non-uniformity in the non-uniform data 125 may arise from differences in the way the data is stored by various data acquisition applications, as well as differences in the types of data being manipulated, as discussed previously. In one aspect, the bioinformatic integration system 100 collects the non-uniform data 125 coming from the data acquisition applications and processes it through a data translator 145, as will be described in further detail below. Each data translator 145 comprises instructions that allow it to receive the non-uniform data 125 and contains further instructions to interpret the non-uniform data 125 and generate formatted data 150, such as XML data, for integration into the data warehouse 155. The data translators 145 will be discussed in greater detail in relation to FIG. 2.

In one aspect, the translator module 190 of the bioinformatic integration system 100 incorporates a plurality of data translators 145 that each include instructions for arranging and processing the non-uniform data 125, representing a plurality of different biological domains, for use in a single data warehouse 155. Of course, it should be realized that the translator could be designed to output any type of structured data and is not limited to only XML output.

In one aspect, a loader module 146 includes instructions for interpreting the XML formatted data 150 and translating the XML formatted data 150 into another structured format 151 for integration into the data warehouse 155. The formatted data 151 is ideally formatted for efficient integration into the data warehouse 155 schema, and comprises database-compatible language, such as SQL statements. This is, in part, accomplished by mapping the formatted data to correspond to appropriate tables defined within the data warehouse 155 as will be discussed in greater detail herein below.

Subsequent operations of query and analysis of the data are then collectively performed using the data warehouse 155 to create an improved method for associating and assessing data and information derived from different biological domains. The integration of this data is possible since the system 100 brings together disparate data types from many different sources.

Association of the non-uniform data 125 presents a particular problem in conventional data analysis systems resulting from the increased difficulty encountered when combining results from various query and analysis applications 135, 140, used to provide the data and information. For example, the non-uniform data 125 and associated fields and information resulting from a typical nucleotide search may have little similarity to the data types and information presented in the data output of a molecular modeling analysis which may contain embedded digital graphic information depicting the structure of a protein complex. Conventional bioinformatic applications are not designed to handle such diversity in data types that result from the use of more than one application to process and analyze the biological data. These limitations are overcome by using data translators 145 configured to transform the non-uniform data 125 of each bioinformatic application 120 into a structured data output, such as XML, which can be subsequently processed and stored in the bioinformatic data warehouse 155. The resulting information repository can thereafter be utilized for sophisticated query and analyses across multiple informational domains and is freed from limitations of data representation as will be discussed in greater detail hereinbelow.

An overview block diagram for entering data and information into the data warehouse 155 is shown in FIG. 2. In one aspect, the bioinformatic integration system 100 is highly flexible and transforms a plurality of different types of data and information into a single unified form to be stored in the data warehouse 155. In one aspect, this feature allows the bioinformatic integration system 100 to analyze data and information across a plurality of biological domains and provides the user of the system 100 with an advantage over existing databases and bioinformatic applications which are limited to comparing only a specific types or subsets of data and information. For example, a typical bioinformatic application designed for nucleic acid analysis is limited by its inability to analyze data and information beyond that of protein, DNA, or RNA domains. Aspects of this system allow data analyses to be extended to any domain which is incorporated into the data warehouse 155 and thus creates a more comprehensive and unified analytical tool.

In the illustrated embodiment, the translator module 190 comprises a plurality of tools designed to transform the non-uniform data 125 of a particular bioinformatic application or from a data acquisition application into XML formatted data 150 suitable for processing by the loader module 146 and subsequent storage in the data warehouse 155. In the illustrated embodiment, the non-uniform data 125 comprises an internal data type 200 corresponding to the non-uniform data 125 from data acquisition applications 180 and a public data type 205 corresponding to the non-uniform data 125 from bioinformatic applications 120.

The internal data type 200 further comprises a plurality of data types which, for example, may include sequence data types 206, expression data types 207, and other internal data types 208. Similarly, the public data type 205 further comprises a plurality of data types which, for example, may include a GenBank data type 209, a SwissProt data type 210, and other public data types 211. It will be appreciated by those of skill in the art, that the data types 200, 205 are not limited to only those listed above and may include data types derived from data output from difference sources and thus represent additional embodiments of the bioinformatic integration system 100.

As discussed above, the data translators 145 comprise a plurality of type-specific data translators, shown here as 216-221. The plurality of data translators 145 are present within the translator module 190 and each include instructions for receiving and converting a specific data type 206-211 into formatted data suitable for processing by the loader module 146. In one aspect, a series of data type translators 216-221 are associated with processing the individual data types 206-211. The data translators 145 may be individual components written to handle exclusively one data type 200, 205 or multi-functional translators designed to handle more than one data type 200, 205. In the illustrated embodiment, the data translators 145 are configured to receive a specific data type 206-211 and to convert the individual data types 206-211 into formatted data 150.

In one aspect, the translator module 190 improves the scalability of the bioinformatic integration system 100 by providing data format flexibility using data translators 145 which are modular in nature. The modular design of the data translators 145 facilitate the development of new translators and improves the ease with which the translators may be integrated into the existing translator 190 as new formats of information and data output become available or existing data output formats are changed or altered. Thus, the bioinformatic integration system 100 includes a flexible front end wherein the translator module 190 is configurable to read and process many different data types 200, 205, reducing the likelihood that the system will become antiquated as new data types become available.

Processing of the non-uniform data 125 by the data translators 145 results in formation of XML formatted data 150. The loader module 146 includes instructions that allow it to acquire the XML formatted data 150 and perform the operations necessary to store the data in the data warehouse 155. In one aspect, the loader module 146 is configured to acquire the XML formatted data 150, convert the XML formatted data 150 into formatted data 245 encoded in a language compatible with storage in the data warehouse 155, and populate individual entities, tables, or fields of the data warehouse 155 with the formatted data 245. The loader module 146 is further configured to interpret and associate the XML formatted data 150 with existing information contained in the data warehouse 155 to produce integrated content and associations, as will be subsequently discussed in greater detail.

In one aspect, the data translators 145 and the loader module 146 utilize a specialized language and parser to convert the non-uniform data 125 into a commonly interpretable data scheme specified by the translator module. The specialized language, such as XML, further serves as a transitional format between the data output types and the language used in the implementation of the data warehouse 155. In the illustrated embodiment, the components of the translator module 190 use extensible markup language, (XML), as a basis for the transitional format to prepare the non-uniform data 125 for storage in the data warehouse 155. It will be obvious to one of ordinary skill in the art that XML is not the only standardized language that could be used as the transitional format for data being passed from the translator 215 to the loader module 146. However, it does present advantages as will be discussed below.

XML is a meta-language and a subset of the standard generalized markup language (SGML) typically used to represent structured data in an application and platform-independent manner. The XML specification possesses a number of properties which improve the data conversion routines used by the translator module 190 and ensure that future upgrades and additions to the bioinformatic integration system 100 are easily transitioned through. Furthermore, the XML language specification is platform-independent and may be used with any computer system which has an XML interpreter. Thus, data exchange between computers or devices sending non-uniform data 125 to the translator module 190 need not be identical thereby improving the flexibility of the system 100 to provide cross-platform formatting and organization of data. Additionally, use of XML improves the ability to separate the content of the non-uniform data 125 from its representation by parsing the non-uniform data 125 into flexibly designated. For a review of the XML specification the reader is directed to Inside XML, by Steven Holzner, New Riders Publishing, 2000.

As previously discussed, the content of the non-uniform data 125 may be organized in any manner desired without restriction to the format of the application or database from which the non-uniform data 125 was derived. This property simplifies data loading of the data warehouse 155 and allows the translator module 190 to function using only one loader module 146 which can receive XML data from any source for which a data translator 145 has been coded. As a result, a significant amount of work is saved when adding and updating data in the data warehouse 155. Furthermore, the number of errors or inconsistencies is reduced by using only one loader module rather than implementing a separate loader for each data type.

The application of XML, used by the data translators 145 to generate the XML formatted data 150, also improves the efficiency of code generation required for interacting with the data warehouse 155. In one aspect, the data translators 145 handle XML code generation automatically and can save large amounts of time compared to loading the non-uniform data 125 into the data warehouse 155 by other methods. Additionally, XML may be used in the generation of new tools which access the databases and information 105, 160 without having to change the hard-coding of the existing database structure or the format of the information. Furthermore, the XML based tools may be reused with little modification improving the flexibility of each existing tool. Therefore, XML is beneficially used in the processing of the non-uniform data 125 and converting the different data types into uniform XML formatted data 150. Subsequently, the XML formatted data 150 is converted to a non-XML format 245 which is compatible with the data warehouse 155 and will be discussed in greater detail hereinbelow.

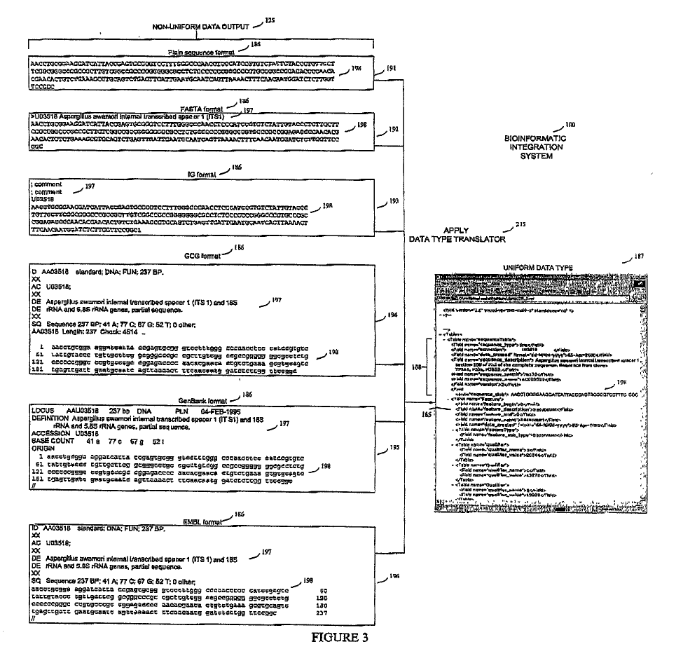

FIG. 3 illustrates one example of the bioinformatic integration system using the data translators 145 to convert non-uniform data 125, comprising sequence information, into a uniform data type 187. In the illustrated embodiment, a plurality of exemplary nucleic acid sequence formats 186 are shown, each having a particular file structure and method of presenting data. Such differences in file format and structure are typically encountered when processing data and information related to bioinformatic systems and result in the accumulation of the non-uniform data 125.

Although the sequence formats 186 correspond to non-uniform data 125 for an identical sequence query, variations in the format and presentation of the data and information is observed and representative of potential difficulties encountered when comparing even similar data types. In the illustrated embodiment, each sequence or data format 186 embodies a commonly used nucleotide sequence representation typically found in conventional nucleotide homology/comparison programs including, for example; plain format 191, FASTA format 192, IG format 193, GCG format 194, GenBank format 195, or EMBL format 196.

The illustrated data formats 191-196 define structured representations used to list and store nucleotide or protein sequence information and may include header areas 197 followed by the actual sequence information 198. The header area 197 may further include descriptive information, such as, for example; accession number, total sequence length, sequence description, literature reference, date, type, sequence check, etc. The data formats 191-196 each present the sequence information 198 in a different way and may include differing amounts and types of information in the header area 197.

In one aspect, the bioinformatic integration system 100 is configured to receive and process each format type 191-196 and to then produce the uniform data type 187 representative of the sequence information 198, as well as information contained in the header area 197 of the particular sequence format 186. The conversion of the non-uniform data 125 into the uniform data type 187 desirably separates the content of the data from its physical representation. Such separation permits the data to be rearranged in a meaningful manner wherein components of the non-uniform data 125 are associated with fields 185 of the uniform data type 187. The resulting fields 185 of the uniform data type 187 form the basis by which the data can be associated and queried following integration into the data warehouse 155.

In one aspect, the uniform data type 187 comprises a plurality of XML instruction sets or classes 188, which code the information of the non-uniform data 125 to be subsequently interpreted by the loader module 146 (FIG. 2) to populate the data warehouse 155. Thus, the bioinformatic integration system 100 is able to represent, combine, and process different data types and formats, with various structural and informational differences, thereby creating the uniform data type 187, which can be further associated with information from other biological domains as will be discussed in greater detail hereinbelow.

It will be appreciated by those of skill in the art that other sequence formats may exist which may likewise be converted to the uniform data type 187 by the bioinformatic integration system 100. Furthermore, other data output formats exist, related to other informational sources and biological domains, which may be converted in a similar manner to the uniform data type 187 containing other data or information and represent additional embodiments of the present invention.

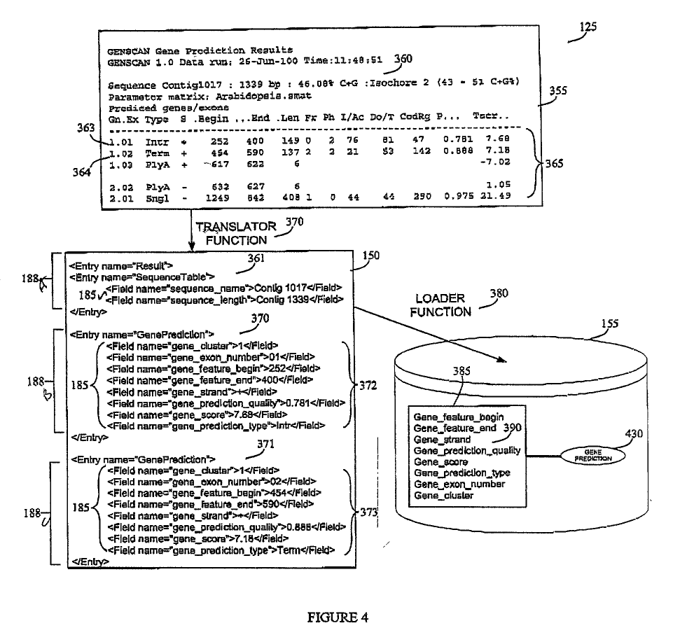

FIG. 4 further illustrates the method by which the non-uniform data 125 is translated into information suitable for storage in the data warehouse 155. In the illustrated embodiment, non-uniform data 125 corresponding to raw data from a sequence prediction program 355 is first converted to XML formatted data 150. The XML formatted data 150 comprises XML instruction sets or classes 188 which separate the non-uniform data 125 into smaller portions which are logically associated. In one aspect, the data contained in each instruction set or class 188 represents individual data groups 365 and contains information which defines aspects or information of the data group 365 provided by the bioinformatic application 120 or data acquisition application 180.

In the illustrated embodiment, two data groups 363, 364 have been processed by a translator function 370 of the translator module 190 wherein the data and information corresponding to the data groups 363, 364 is transformed into XML instruction sets or classes 188 defining the information. The XML instruction sets or classes 188 comprise a plurality of fields 185 which isolate and store information from the data groups 365 using the translator function 370. Thus, the first data group 363 is converted into XML code defined by a first instruction set 370 and is further separated into descriptive fields 372 which refine and store the data contained in the first data group 363. In a similar manner the second data group 364 is transformed into XML formatted data representing a second entry 371 and associated fields 373 storing the values present in the second data group 364. Additionally, other information 360 present in the raw data 355 may be extracted and encoded by other instruction sets or classes 361.

In one aspect, the translator function 370 of the translator module 190 recognizes the file structure and format of the data 363, 364 and parses it to produce the XML representation 188 of the data and information. Data integration from different informational sources 105, 160 is desirably achieved by processing the contents of the non-uniform data 125 with an appropriate translator function 370 whereby the information from a plurality of different data types is converted into uniform/formatted data. Furthermore, the translator module 190 separates the data and information into logical instruction sets, classes or subdivisions 188 using XML entries and fields which can be loaded into the data warehouse 155 as will be discussed in greater detail hereinbelow.

Following completion of the translator function 370, wherein all of the data and information for a particular file or informational block has been processed, a loader function 380 of the loader module 146 further processes the resulting XML formatted data 150 to prepare the information contained in the instruction sets or classes 188 for storage in the data warehouse 155. The loader function 380 desirably interprets the XML formatted data 150 and converts the information into a data warehouse compatible form. In one embodiment, the XML formatted data 150 is automatically translated into database instructions and commands such as SQL statements. The resulting database instructions are executed to store the XML formatted data 150 in a table 385 which defines each database component 430 or domain maintained by the data warehouse 155. Additionally, the fields 185, defined in the XML formatted data 150, are desirably converted to an appropriate format for storage in an associated database field 390 which make up the table 385 defining the database component 430 or biological domain.

Although a single database component 430 and associated table 385 is shown in the illustrated embodiment, it will be appreciated by those of skill in the art that the translator and loader functions 370, 380 of the bioinformatic integration system 100 may be used to populate a plurality of attributes within the same table or other tables. In one aspect, the arrangement of attributes and tables 385 desirably represent the collection of biological domains stored by the data warehouse 155 and may be arranged in numerous ways or use other methods to organize the information and to facilitate subsequent analysis.

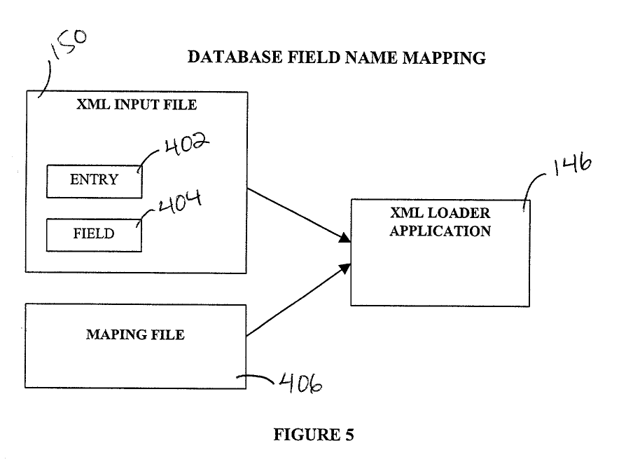

As illustrated in FIG. 5, in one embodiment, a mapping file 406 is provided to relate the XML formatted data 150 to the appropriate storage locations in the data warehouse 155. In one aspect, the XML formatted data 150 is comprised of entries 402 and fields 404 to separate the data into smaller related components that are logically associated. For example, an entry 402 defines a table, where a field 404 defines a row contained within that table. In this sense, the XML formatted data 150 is logically broken down for easy integration with the tables and rows already contained within the data warehouse 155. However, problems may arise when the XML formatted data 150 contains information that has no corresponding entry in the data warehouse 155.

For example, data acquired from a public database through using a bioinformatic application may use different terminology or formatting for data already contained within the data warehouse. Without resolving differences in terminology or formatting, the data warehouse may become populated with duplicative information that is not logically associated with other relevant data. For example, if the data warehouse contains a table under the heading “FeatureType” while the data acquired from a public database uses the heading “Type of Feature,” these identical entries may both be stored in the data warehouse 155 which causes an inefficient schema, a larger than necessary database, and may result in inefficient searches because one of the identical entries may not be properly associated with other relevant data. The discrepancy between the formatting of the heading text needs to be resolved to result in a more efficient data warehouse 155. To this end, FIG. 5 presents one embodiment that employs a mapping file 406 to resolve differences in terminology or formatting between the acquired data and the data warehouse 155.

The mapping file 406 contains instructions that allows the loader module 146 to transpose one word or group of words for another. For example, as the loader module 146 receives the XML formatted data 150, it additionally receives the mapping file 406. The loader then parses the mapping file 406 and inserts instructions into the resulting Formatted Data 245 corresponding to the logical relations found within the data warehouse 155. The mapping file 406 may take the form:

<Mapping>
<LoaderMap>
<XmlMap>

<Map type=“table” from=“Type of Feature” to=“FeatureType”/>
<Map type=“table” from=“MyClone” to=“Clone”/>
<Map type=“table” from=“MyUserSetSequence”
to=“UserSetSequence”/>

</XmlMap>
</LoaderMap>
</Mapping>

The above example demonstrates one possible format for mapping a table name acquired from bioinformatic applications 120 or data acquisition applications 180 to another table name stored in the data warehouse 155. The first line beginning with “<Map type=“table”” specifies that a mapping correspondence is immediately following and the element to be mapped is a table. The code then discloses the text to be transposed, “Type of Feature” and the resulting text to be inserted in its place “FeatureType”. Hence, the differences in terminology are resolved through the integration of a separate mapping file 406 that contains the appropriate information to logically associate the data with other relevant data in the data warehouse.

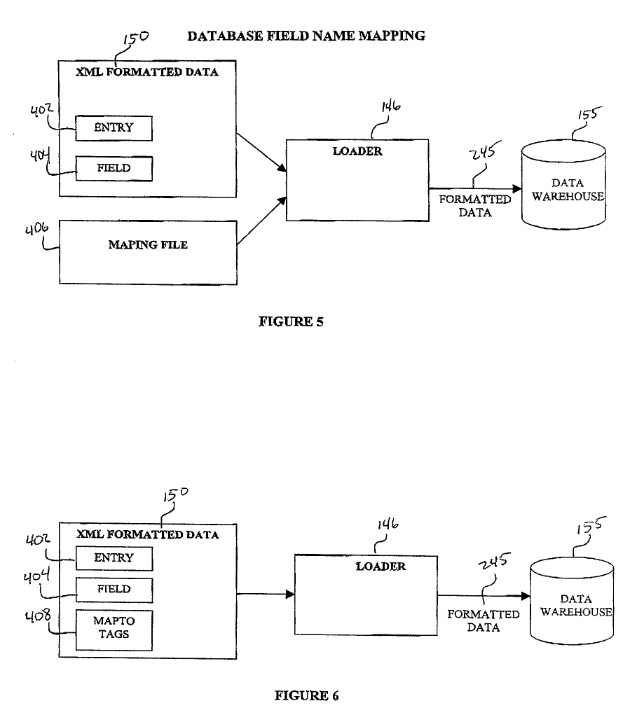

FIG. 6 illustrates yet another embodiment and method for resolving differences in data terminology or formatting to ensure the proper insertion and relationships in the data warehouse 155. In this embodiment, the XML formatted data 150 is comprised of an entry 402, a field 404 within the entry, and one or more mapto tags 408 contained within an entry. This embodiment provides the added benefit of having all the necessary mapping functions contained within a single file and does not require a user to manually create or select an appropriate mapping file. In one aspect, the translator module 190 (of FIG. 2) is comprised of individual data translators 145 that each include instructions on how to appropriately map the data coming from the respective data translator 145. For example, the GenBank Data translator 219 may contain instructions to automatically transpose the standard GenBank heading “Type of Feature” into the data warehouse heading “FeatureType.” While this results in an increase of code to the data translators 145 and may reduce the flexibility of allowing one data type translator to work with multiple sources, it provides automation of the mapping process. However, a manual mapping process may still be realized by using a software data mapping module as is discussed hereinbelow.

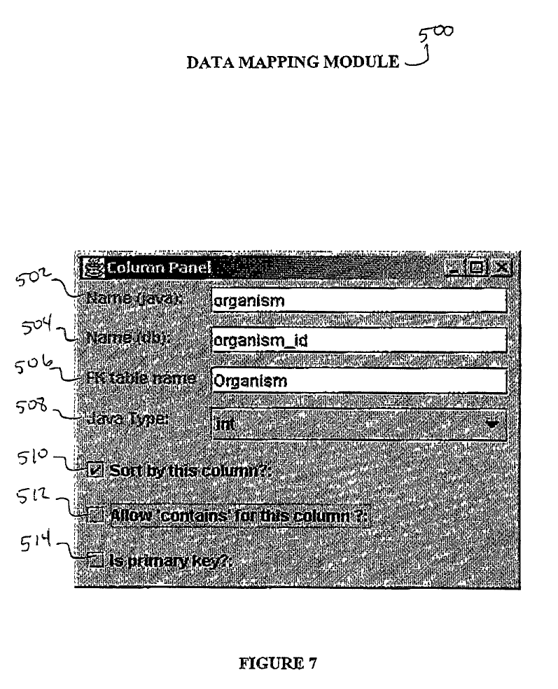

FIG. 7 illustrates one embodiment of a data mapping module 500 wherein fields are provided for manually inputting the fields to be mapped and their respective data warehouse values. For example, the Name (java) field 502 allows a user to specify the field as provided by the data source, such as a public database. The Name (db) field 504 contains the data warehouse field name, and is the text string that will be used to replace the string contained in the Name lava) filed 502. The FK table name field 506 contains the name of the appropriate table in which to store the entries specified in the Name (db) field 504. Therefore, the terminology supplied by the public database is transformed to correspond to the terminology used in populating the data warehouse. Furthermore, a specific table within the data warehouse is provided in which to store the relevant entries corresponding to the data entry comprising the Name (db) field 504. A Java type field 508 is provided to specify the data type of the entry being provided. Possible entries for the Java type field 508 include the values: integer, long, float, double, String, Date, Clob, and Blob. It should be obvious to one of ordinary skill in the art that this list is not comprehensive and any data type recognized by the JAVA programming language could be used.

Further illustrated in this embodiment is a Sort by this column checkbox 510 that specifies whether or not the entry, once archived in the data warehouse, should be used to sequentially sort the data entries corresponding to the value of the Entry specified. As an example, suppose an entry name acquired from a public database contained the string “Accession Number.” The Name (java) field 502 would correspond to the entry name provided by the public database, and would hence, also contain the string Accession Number. Further assume that the data warehouse contains an entry for the string accession_number. Because these data descriptions are not formatted identically, a mapto tag can be utilized to resolve the discrepancy. Therefore, the Name (db) field 504 would need to contain the string accession_number. The FK table name field 506 would contain a table name in which to store the data entry, such as Sequence Accession Number. Because an accession number is usually specified as an integer, the Java type field 508 would have integer as the selected value. Based on this example, the appropriate lines of code contained in the XML formatted data might be represented as:

<Entry table=“Sequence Accession Number”>

<Field name=“Accession Number” type=“integer” mapto=“accession_number”>U03518</field>

</Entry>

With the Sort by this column checkbox 510 checked, the value, “U03518” in this example, will be entered in sequential order, either alphabetically or numerically within the Sequence Accession Number database table. This particular embodiment also provides an Allow contains checkbox 512 which, when selected, allows a user to search and retrieve this data entry by specifying characters contained in the data entry. This makes it possible to retrieve multiple entries all containing a common string. For example, all sequences could be returned containing the string “U035.” This is especially useful when trying to retrieve results that all contain a common characteristic, rather than having to search for them individually. This is analogous to utilizing wildcard characters as is generally known in the art.

Finally, in one embodiment, a Primary key checkbox 514 is provided which controls how the entry is stored and associated in the database. As in generally known in the art, a database typically comprises primary and foreign keys. These keys allow one table to be related to another table, and the data contained in those table to be logically associated. This is accomplished when a primary key of a parent table references a foreign key in a child table, and the remaining data in both tables can be logically joined to provide more detailed information about the primary or foreign keys. When the Primary key checkbox 514 is selected, the database associates the table to relevant child tables containing the corresponding foreign key and thus, a logical association is created.

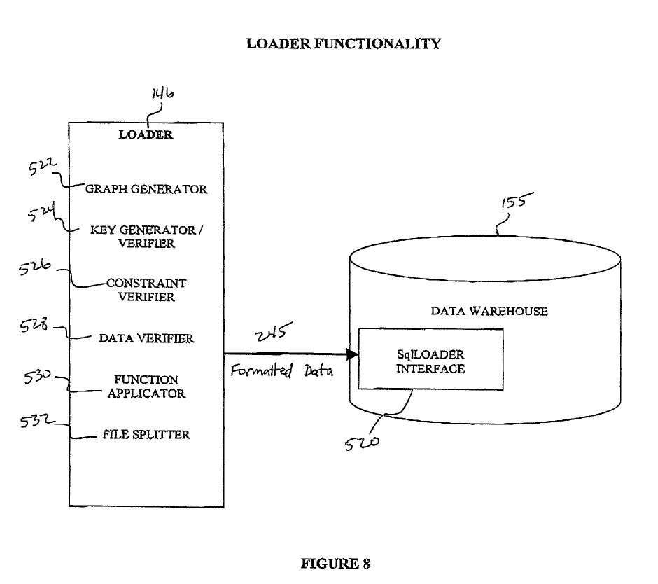

FIG. 8 illustrates several functional capabilities of a generic Loader. As has been described herein, the loader module 146 receives XML formatted data, may integrate a mapping file into the XML formatted data, translates the data into formatted data suitable for integration with a data warehouse, such as SQL statement form, and archives the data to a data warehouse 155 through the database's SqlLoader interface 520. Additionally, the loader module 146 comprises additional modules 522-532 for increased functionality and ease of use as will be described in greater detail below.

The loader module 146 includes a graph generator 522 module for generating a directed acyclic graph for the database tables. This allows the loader module 146 to automatically handle foreign key constraints in the proper order. For example, if an entry to be inserted into the data warehouse 155 contains a primary key, the loader will automatically process those tables containing the relevant foreign key before processing the table containing the primary key. This results in the database tables containing the proper logical relations to one another which results is more efficient searching of the database.

In conjunction with the graph generator 422 is a key generator/verifier 524. This module allows the loader to handle primary and foreign key constraints automatically. This is accomplished by verifying whether the data to be loaded already exists within a table contained in the data warehouse 155, and if not, a new primary key is created corresponding to the data entry being processed. The resulting primary key is created either by querying a sequence in the data warehouse and arriving at the correct primary key string, or by incrementing the highest primary key value by one in the case of an integer primary key. If the loader finds that the data entry already exists in a row of a table contained in the data warehouse 155, the values for the primary and foreign keys are retrieved and properly assigned in the table being inserted into the data warehouse 155. Thus, the new data being stored into the data warehouse is associated with other relevant information.

In one embodiment, a constraint verifier 526 is provided for assuring that all required fields are present, and if not, generates an error message to that effect. The XML formatted data contains a “required” attribute that specifies when a particular field is present. The “required” attribute is located within a tag, such as a field tag, and usually takes the form <field name=“date_created” type=“Date” formate-“dd-MM-yyyy” required=“true”>. In this example, when an entry contains this date created field, the date of creation is required in order to process the entry and store the value in the data warehouse 155. If the date of creation is not present in the data entry, an error message is generated and the user is prompted to enter the date of creation in order to store the entry into the data warehouse. The constraint verifier 526 further parses the database schema and determines which fields are unique in a table. Thereafter, when an entry is inserted into a table, the constraint verifier 526 assures that all the unique fields are specified. This results in a more complete database because the fields unique to a given table must be filled, and then the proper logical associations are made to the unique table fields.

Alternatively, where a field is not necessarily required, a data verifier 528 is provided in order to more fully complete a data entry. If an entry is missing information, the data verifier 528 attempts to parse the data warehouse 155 and fill in the missing information. In one aspect, if a data entry is missing information, the data verifier 528 accesses the primary key associated with the table the data is being inserted into, finds tables having corresponding foreign keys, and parses those tables to look for the missing information corresponding to the data entry. The missing information can thus be retrieved from other entries contained in the database that are logically associated with the data entry being processed.

In order to more efficiently deal with numerical values to be loaded into the data warehouse, a function applicator 530 is provided to perform a variety of mathematical functions on the numerical values. For example, in order to more efficiently deal with extremely large or small values, the logarithm may be applied to the value before it is stored in the data warehouse. Likewise, other values may be rounded to a whole integer to make data retrieval more efficient. As an example of the realized efficiency of performing function on numerical values, the code “<Field name=“ph_value” type=“double” function=“log”>0.0000000000000000004456</field>” stores the result as −18.35, thereby reducing the significant digits stored from 23 digits to 4 digits. Reducing the number of digits additionally allows a technician to compare values more efficiently. Other functions that may be applied include: log, exp, round, floor, ceil, tan, sqrt, sin, and cos. It should be obvious to one of ordinary skill in the art that numerous functions are available, such as the functions contained in the java.lang.Math class of the JAVA programming language.

While loading large files, it becomes advantageous to manage the file or files in smaller portions. This is due, in part, to the time required to load large files, errors contained in one portion of the file may cancel the entire loading process, and multiple entries can be loaded without having to manually start the process for each entry. To this end, the loader module 146 contains a file splitter module 532 for splitting large files into smaller portions. For large files that are contain just one type of data, such as organisms, sage data, or sequences, an internal file splitting algorithm is provided to automatically handle these large files.

For large files with complicated graphs, such as assemblies, several options are presented to allow a user to specify how the file should be handled. For example, settings controlling the maximum memory to be used, maximum number of entries per level, and an option to delete a file portion after successful loading are provided. Because of the complex nature of biological information, files can have an enormous amount of information and therefore take up a large amount of storage space. For example, it is not uncommon for a file containing biological information to require gigabytes or terabytes of storage space. The ability to split these large files into smaller portions, especially when the particular type of data is not currently contained in the data warehouse, allows a technician to successfully test the data structure and integrity of the particular file type before devoting large amounts of time and computer resources to dealing with a large file. Furthermore, splitting a file allows errors within the file to be isolated and not affect the loading of the remainder of the file.

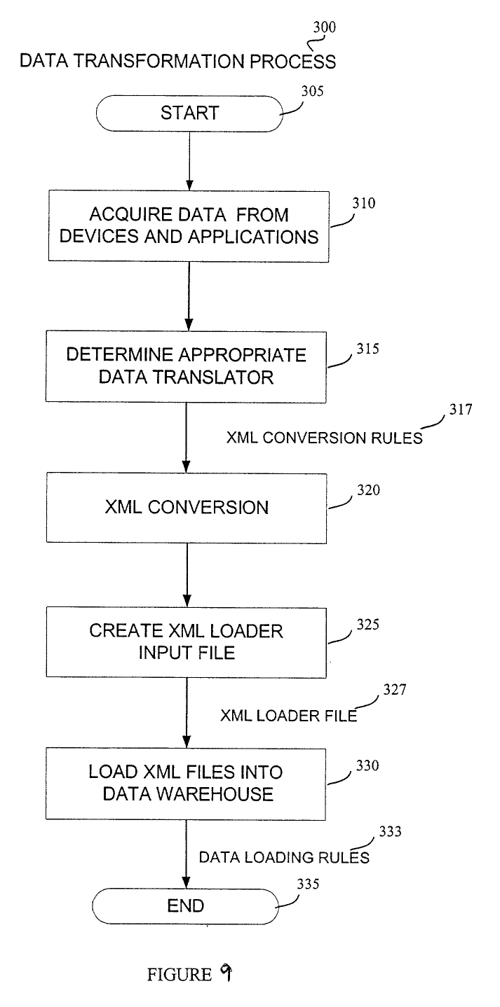

FIG. 9 illustrates a data transformation and loading process 300 by which data output 125 is converted into a uniform format and stored within the data warehouse 155. Beginning in a data transformation start state 305, the process 300 proceeds to a state 310 where non-uniform data output 125 is acquired from devices and applications. In one aspect, the acquired data is derived from the data output 125 of the bioinformatic applications 120 or data acquisition applications 180, as previously mentioned (FIG. 1). The process 300 then moves to a state 315 wherein the translator module 190 receives the data output 125 and determines the appropriate data translator 146 to use. In one aspect, the translator module 190 automatically recognize the data type 200, 205 by scanning the file structure or recognizing the data format and subsequently applying the data translator 145 associated with the specific file or data type.

Alternatively, the translator module 190 may recognize the filename or extension of the file in which the data is stored and may associate it with the use of a particular data translator 145.

Following recognition of the format of the data output 125, the process 300 moves to a state 320 wherein an XML conversion is performed on the data using the appropriate data translator 145. The XML conversion converts the non-uniform data output 125 into XML data 150 which represents the data output 125 in a form designated by a plurality of XML conversion rules 317. The XML conversion rules 317 are associated with each data type translator 145 wherein the rules 317 specify how the information from the data output 125 is extracted and incorporated into the resulting XML data or file structure comprising the transformed data 150.

Following XML conversion of the data output 125 at a state 320, the process 300 proceeds to a state 325 wherein a formatted data file 245 is created and follows a set of mapping rules 322 to incorporate mapping information derived from either a mapping file 406 or integrated mapping information in the form of mapto tags 408 as depicted in FIGS. 5 and 6 respectively. Subsequently, the Loader module 146 loads the transformed data 330 in the data warehouse 155 according to a set of data loading rules 333.

The data transformation and loading process 300 is complete when the data warehouse 155 has been suitably loaded 330 with the formatted data 245 and the process reaches an end state 335. The data transformation process 300 is desirably repeated, as necessary, to populate the data warehouse 155 with information which may be subsequently queried and analyzed. In one aspect, the XML formatted data 150, coded by XML instructions, is converted to a plurality of instructions which are compatible with the native processing language used by the data warehouse 155. Additionally, other instructions may be incorporated into the XML formatted data 150 to carry out other functions associated with maintaining the data warehouse 155, interacting with other accessory programs or applications, insuring data integrity and the like.

In one aspect, the data warehouse 155 comprises a relational database developed from a conceptual data model which describes data as entities, relationships, or attributes. This model is particularly suitable for associating diverse data sets and categories, such as those found in the different data domains of the biological applications 120. Using the relational model, associations between data types and fields of data output 125 from the bioinformatic applications 120 are made which link or define how the data and information is related.

The relational model for database development farther allows the data warehouse 155 to be constructed in a highly flexible manner which may easily accommodate new data and information types, without the need to spend large amounts of time in redesigning the data warehouse 155.

While certain embodiments of the invention have been described, these embodiments have been presented by way of example only, and are not intended to limit the scope of the present invention. Accordingly, the breadth and scope of the present invention should be defined in accordance with the following claims and their equivalents.

What is claimed is:

1. A system for storing and integrating data entries into a biological data warehouse comprising: a loader module which receives data in a transitional format, converts the transitional format into formatted data, and stores the formatted data in a data warehouse.

2. The system of claim 1, wherein the transitional format comprises a markup language used to represent the data entries.

3. The system of claim 2, wherein the markup language transforms said data entries into an application and platform-independent form.

4. The system of claim 3, wherein the markup language comprises extensible markup language definitions.

5. The system of claim 1, wherein the transitional format is converted into a database-compatible language.

6. The system of claim 5, wherein the database-compatible language comprises SQL statements.

7. The system of claim 1, further comprising a graph generator for generating a data warehouse graph.

8. The system of claim 7, wherein said data warehouse graph is used to represent the schema of said data warehouse, wherein said data entries may be processed in a logical order.

9. The system of claim 1, further comprising a data verifier for comparing said data entries with data present in said data warehouse.

10. The system of claim 9, wherein said data verifier is configured to populate incomplete data entries by retrieving the missing information from the data warehouse.

11. The system of claim 1, further comprising a key generator wherein primary and foreign database keys are created within said data warehouse.

12. The system of claim 1, further comprising a file splitter for splitting large data files to facilitate easier loading of complex data files.

13. A method for storing and integrating biological data into a biological data warehouse comprising the steps of:
a. receiving data in a transitional format;
b. converting said data into a database-compatible language; and
c. storing said database compatible language in a biological data warehouse.

14. The method of claim 13, including the further step of integrating mapping information into the formatted data.

15. The method of claim 14, wherein said mapping information is a mapping file.

16. The method of claim 14, wherein said mapping information is embedded within said transitional formatted data.

17. The method of claim 13, wherein said transitional format comprises extensible markup language definitions.

18. The method of claim 13, wherein said database-compatible language comprises SQL statements.

19. A system of loading information into a database comprising:
a. translating means for converting data from a transitional format into a database-compatible language;
b. mapping means for corresponding said data with data present in said database; and
c. loading means for storing data into said database.
